(19) United States
(12) Patent Application Publication
(10) Pub. No.: US 2019/0179927 A1
(43) Pub. Date: Jun. 13, 2019

(54) ENTERPRISE DATA SERVICES COCKPIT

(71) Applicant: Paypal, Inc., San Jose, CA (US)

(72) Inventors: Anita P. Rao, Cupertino, CA (US); Alejandro Picos, San Jose, CA (US)

(21) Appl. No.: 15/838,157

(22) Filed: Dec. 11, 2017

(51) Int. Cl. G06F 17/30

(52) U.S. Cl. CPC G06F 17/30309; G06F 17/30424; G06F 17/3056

(57) ABSTRACT

Methods and systems for generating intelligent actionable information based on tracking and monitoring movements and lineage data across multiple database nodes within an enterprise system are described herein. Data within an enterprise system may be collected and monitored to generate real-time intelligent analytics and predictive insights for presentation. The changes and movements of each data across multiple database nodes within the enterprise system may be monitored, and deviations from a scheduled data flow associated with the data may be traced. Based on the monitoring and tracking of the changes and lineage of the data, performance metrics may be generated along with predictions and prescriptions to improve them. The performance metrics may be visualized via one or more performance reports in response to a user request.

### BACKGROUND

The present specification generally relates to data analytics and visualization systems for deriving intelligent information for an enterprise.

### RELATED ART

Decision makers, such as executives, project managers, and the like, often rely on useful and accurate data to make decisions for an organization. With the advent of networked computing devices to collect and store information as digitized data, information can now be accessed almost at any time and from anywhere. The volume, variety, velocity, and veracity of data collected in an enterprise have exploded. However, much of the information stored and collected for an organization remains unorganized and while accessible, provides little value to the decision makers. For example, prior studies have shown that on average, only approximately 5% of the total information collected is considered useful by the decision makers. Furthermore, approximately 80% of the time is spent on scrubbing and cleaning data for use while only 20% of the time is used for analysis of the data. Additional complexity is introduced when data moves among various transactional systems, which is aggravated as the enterprise makes acquisitions and new systems are added. Thus, there is a need for improved data wrangling, analytics, and visualization systems that process and present data in an intelligent manner to increase the amount of useful information for decision makers.

### BRIEF DESCRIPTION OF THE FIGURES

FIG. 1 is a block diagram illustrating a data analytics and visualization system according to an embodiment of the present disclosure;

FIG. 2 illustrates monitoring and tracking data according to an embodiment of the present disclosure;

FIGS. 3A and 3B are example interactive interfaces generated by the data analytics and visualization system according to an embodiment of the present disclosure;

FIG. 4 is a flowchart showing a process of providing a visualization of intelligent enterprise data according to an embodiment of the present disclosure; and

FIG. 5 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for tracking, measuring, and generating intelligent information based on monitoring changes and movements of data across multiple database nodes within an enterprise system. According to various embodiments of the disclosure, data from different domains and database systems within an enterprise system may be collected and monitored in real-time to generate intelligent analytics for presentation. The changes and movements of each data across multiple database nodes within the enterprise system may be monitored in real-time, and deviations from a scheduled data flow (e.g., deviations from the data flow requirements set forth in a service level agreement) associated with the data may be tracked. Based on the monitoring and tracking of the changes and movements of the data, real-time performance metrics may be generated for each data (e.g., how closely the data tracks the scheduled data flow when moving from a predefined source to a target, etc.). The performance metrics may then be used to proactively generate one or more performance reports for presentation in response to a user request. For example, the generated performance reports may be presented on a dashboard interface. Since the performance reports are generated based on real-time tracking of data, users may confidently use the information presented in the reports to make decisions.

According to various embodiments of the disclosure, the performance metric of a data may include outcome data indicating one or more performance issues related to the data at each of the database nodes along the scheduled data flow. For example, the outcome data may indicate whether the data has been modified in an expected way or in an unexpected way, or whether the data has arrived at a particular database node on time or late by a certain time. The data and the performance metrics may be stored in a cockpit database according to a predefined schema separate from the database nodes within the enterprise system.

Queries may be generated according to the various types of data that are stored in the database nodes and/or the structure of the enterprise system. For example, a query may be generated to retrieve the data and associated performance metrics corresponding to one or more domains within the enterprise system, and another query may be generated to retrieve the data and associated performance metrics corresponding to one or more work flows defined by the enterprise system. These queries may be run against the cockpit database to obtain result sets. In some embodiments, these queries may be run even before receiving any user requests. For example, the queries may be run according to a pre-defined schedule. Upon receiving a user request, one or more of the queries may be matched with the user request. The result sets of the one or more queries may then be retrieved and used to generate a report (e.g., a performance report, a dependency report, etc.). The report may then be presented to the user, for example, on a dashboard interface.

In some embodiments, the report may be presented via an interactive user interface (e.g., an interactive webpage). The interactive user interface may enable the user to interact with the presented data. In some embodiments, an interaction with the presented data via the interactive user interface may be translated into a different set of queries. In response to such an interaction, the result set generated from running the different set of queries against the cockpit database may then be retrieved and presented via the interactive user interface.

For example, the user may initially want to see a number of software bugs or data quality issues for a work flow over the last twelve months. A first pre-generated query may be matched with such a request and a result set associated with the query may be presented to the user. The user may then interact with the interface to request to see details of a particular bug or a particular data quality issue. A second pre-generated query may then be matched with this subsequent request, and the result set (e.g., details of the bug or issue, a potential cause of the bug, a potential source with data lineage, etc.) may be presented to the user.

Different embodiments may use different approaches to present the result set generated from the second query. For example, the result set generated from the second query may be presented as an overlay or a pop-up window on top of the result set generated from the first query. Instead of an overlay, the result set generated from the second query may be presented in a separate interactive user interface (e.g., a separate webpage).

The user request may also come in different forms. Instead of an interaction with the presented data, the user request may be provided in a text box and may include natural language. In such embodiments, the system may also include a natural language processor to derive semantics based on the received request in natural language and then map the derived semantics to one or more of the different pre-generated queries.

According to various embodiments of the disclosure, trend data may also be generated based on the performance metrics generated in the past. For example, the generated trend data may indicate a volume of data of certain data types moved across a series of database nodes within a period of time (e.g., within a certain month of the year). The generated trend data may also indicate a volume or a proportion/ratio of performance issues to data volume related to data in certain data types. Based on the trend data, potential performance issues in the future may be predicted. Furthermore, when a performance issue or a trend of performance issues is identified, the movements of the data related to the performance issue(s) may be traced back to identify a cause of the performance issue(s). In some embodiments, a suggestion to prevent future performance issues may also be generated based on the identified cause.

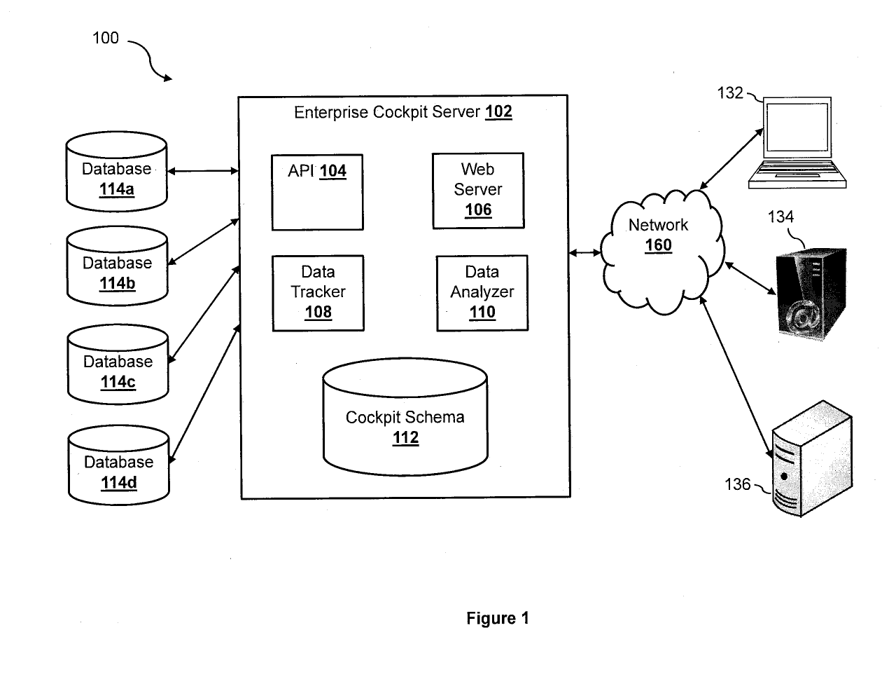

FIG. 1 illustrates a data analytics and visualization system 100 according to various embodiments of the disclosure. According to various embodiments of the disclosure, the data analytics and visualization system 100 may collect, monitor, and track data across an enterprise system and may generate intelligent analytics based on the data to users. The data analytics and visualization system 100 may include an enterprise cockpit server 102 that is communicatively coupled with multiple database nodes (e.g., database nodes 114a-114d) within an enterprise system. The enterprise cockpit server 102 may be implemented as one or more stand-alone server machines. Exemplary servers may include, for example, enterprise-class servers operating a server operating system (OS) such as a MICROSOFT® OS, a UNIX® OS, a LINUX® OS, or another suitable server-based OS. It can be appreciated that the enterprise cockpit server 102 illustrated in FIG. 1 may be deployed in other ways and that the operations performed and/or the services provided by the enterprise cockpit server 102 may be combined or separated for a given implementation and may be performed by a greater number of servers.

While only four database systems are shown in this figure, it has been contemplated that any number of database systems may be incorporated within the data analytics and visualization system 100 without departing the spirit of the disclosure. Each of the databases 114a-114d may store and maintain various types of information for an enterprise system. Each of the databases 114a-114d may comprise or be implemented in one or more of various types of computer storage systems (e.g., servers, memory) and/or database structures (e.g., relational, object-oriented, hierarchical, dimensional, network) in accordance with the described embodiments. In addition, each of the databases 114a-114d may be managed by an application layer such as Hadoop®, Unica®, Oracle® Database Software, and the like. It is, noted that each of the databases 114a-114d may store data in a persistent/non-volatile data storage (e.g., a flash drive, a hard drive, etc.) such that the data stored in the databases 114a-114d may persist over power cycles of the databases 114a-114d.

The data stored in the databases 114a-114d may be managed by different domains within the enterprise system, such as different project groups within the enterprise, different departments within the enterprise, and the like. In some embodiments, at least a portion of the data is shared by the different domains and/or different work flows. For example, some of the data stored in the databases 114a-114d may be used by different domains in their respective work flows. Different work flows may use the data in different ways and may cause the data to move across two or more database nodes. For example, a first workflow may send first data from the database 114a to the database 114c, and then to the database 114d. A second workflow may use the first data by sending the first data from the database 114d to the database 114b. In some embodiments, information related to these pre-defined work flows for each data may be stored as metadata of the data, such that the enterprise cockpit server 102 may track the data and also the dependency of different work flows accordingly, as will be discussed in more detail below.

As shown, the enterprise cockpit server 102 may include an application programming interface (API) module 104, a web server module 106, a data tracker module 108, a data analyzer module 110, and a cockpit schema database 112. The API module 104 interfaces to the various database nodes (e.g., the databases 114a-114d), and enables the data tracker module 108 to retrieve data from the database nodes and/or monitor movements of the data across the database nodes. In some embodiments, the API module 104 may establish a universal protocol for communication of data between the API module 104 and each of the database nodes 114a-114d. In other embodiments, the API module 104 may generate a data request (e.g., a query) in any one of several formats corresponding to the different types of databases 114a-114d. Based on a request for data intending for a specific database from the data tracker module 108, the API module 104 may convert the request to a data query in a format (e.g., an SQL query, a DMX query, a Gremlin query, a LINQ query, and the like) corresponding to the specific database.

In some embodiments, at least a portion of the databases 114a-114d may automatically push data to the data tracker module 108 through the API module 104 upon detecting one or more conditions. For example, one or more of the databases 114a-114d may be configured to automatically push new data to the data tracker module 108 when new data is created or received at the databases.

Once new data is received, the data tracker module 108 may begin monitoring changes and movements of the data across the database nodes 114a-114d. The data tracker 108 may first determine one or more scheduled data flow of the data, and then monitor how closely the movements of the data track the scheduled data flow. Each of the one or more scheduled data flows may indicate a movement path across two or more database nodes. In some embodiments, a scheduled data flow may also indicate a specified time when data should be moved from one database node to another database node. As such, the data tracker 108 may monitor the movements of the data to determine if and how much the actual movements of the data deviate from the scheduled data flow. In addition, the data tracker 108 may also determine if the data changes while the data is stored in a database node, and if the data changes when the data is moved from one database node to another database node.

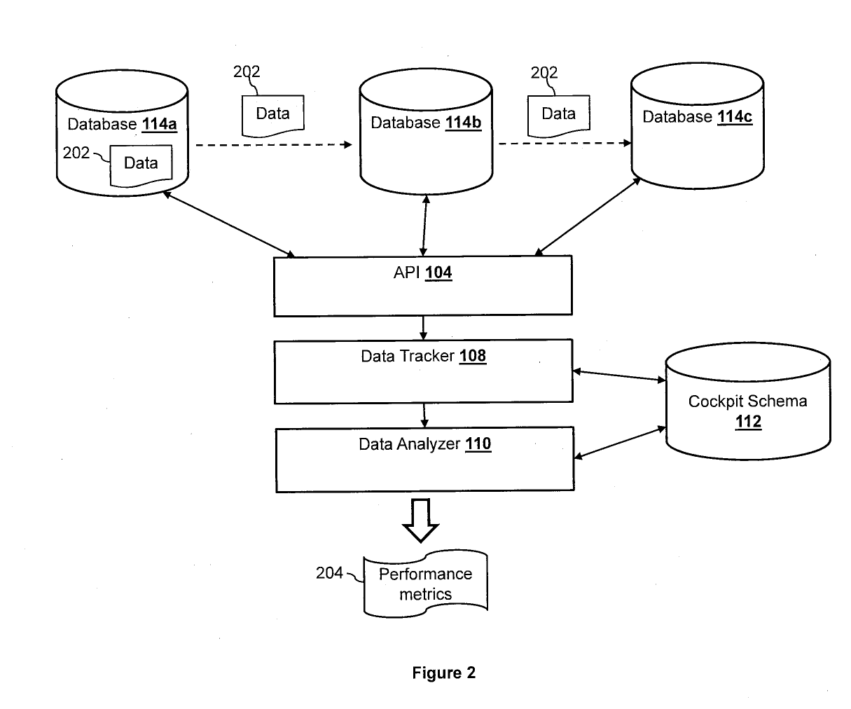

FIG. 2 illustrates monitoring and tracking data by the enterprise cockpit server 102 according to various embodiments of the disclosure. In this example, data 202 may be generated at the database node 114a as new data. As discussed above, the database 114a may be configured to automatically push the data 202 to the data tracker 108 when the data 202 is generated. In other embodiments, the data tracker may periodically pull newly generated data from each of the databases 114a-114d (e.g., every day, every hour, etc.), via the API module 104. The data 202 may include metadata that indicates one or more work flows and one or more scheduled data flow associated with the data 202. The metadata may be, for example, inserted by a work flow that generated the data 202, or by another work flow that makes use of the data 202. In some embodiments, the metadata may be generated by the enterprise cockpit server 102. For example, the enterprise cockpit server 102 may generate a data flow for the data 202 as the data 202 is created and stored in the database node 114a. The enterprise cockpit server 102 may generate the data flow based on, for example, a data type, and a work flow associated with the data 202 (e.g., the work flow that created the data 202).

In this example, the metadata of the data 202 indicates a scheduled data flow from the database node 114a to the database node 114b at 9:30 AM by work flow ‘A,’ and then from the database node 114b to the database node 114c at 10:30 AM by work flow ‘B.’ The scheduled data flow may be contributed by multiple work flows associated with the data 202. For example, a first work flow may cause the data 202 to move from the database node 114a to the database node 114b, while a second work flow may cause the data 202 to move from the database node 114b to the database node 114c. Based on the information, the data tracker module 108 may send a request (e.g., a query) to the database 114b at 9:30 AM to inquire whether the data 202 is received at the database node 114b. If the response from the database 114b indicates that the data 202 is not in the database 114b, the data tracker module 108 may periodically ping the database node 114b thereafter (e.g., every 10 seconds, every 5 minutes, etc.) until either the database node 114b indicates that the data 202 has arrived or a predetermined time (e.g., an hour, a day) has passed. When the database node 114b indicates that the data 202 has arrived in response to a subsequent request after the initial request, the data tracker may note the actual arrival time and/or a time of delay from the scheduled time. When the database node 114b does not indicate that the data 202 has arrived after the predetermined time, the data tracker module 108 may indicate to the data analyzer module 110 that the data 202 has failed to move from the database node 114a to the database node 114b.

In addition to determining whether the data 202 has moved according to the path of the scheduled data flow on schedule, the data tracker module 108 may also determine a condition and/or a status of the data 202 as it arrives at the database node 114b. For example, the data tracker 202 may retrieve a copy of the data 202 from the database node 114b and compare the copy of the data 202 retrieved from the database node 114b with a copy of the data 202 that was stored in database node 114a. Thus, the data tracker 108 may determine whether the data has been changed when the data is stored in the database node 114a or whether the data has been changed during transit between the database node 114a and the database node 114b. The data tracker module 108 may determine any differences between the two copies and provide that information to the data analyzer 110. In some embodiments, the data tracker 108 may also store the retrieved data 202 (e.g., different copies of the data 202 at the different database nodes) and the information related to the monitoring of the data 202 (also referred to herein as “outcome data”) in the cockpit schema database 112 according to a cockpit data schema. In addition to checking whether the data is changed in an expected way, the data tracker module 108 may perform other types of data quality checks (such as null quality check, validity quality check, integrity quality check, de-dupe quality check, and business rule quality check) and store the outcome in the cockpit schema database 112.

Furthermore, the data tracker module 108 may also monitor which work flow moves the data 202. Such a monitoring may serve a variety of purposes. For example, the data tracker module 108 may determine whether the data 202 was moved by an expected work flow according to the associated scheduled data flow, and may provide a warning or preventive measures (e.g., denying further movement of the data 202 by such a work flow) if the data 202 was moved by an unexpected work flow. Moreover, the data tracker may also compile information of which work flow(s) actually moves and makes use of the data 202 for generating dependency data and dependency reports, which will be discussed in more detail below. For example, by monitoring the movement and changes of the data 202, the data tracker module 108 may track which one or more work flows are responsible for causing the movements and/or changes of the data 202 across the different database nodes. The dependency data may be used to generate the dependency reports for presentation.

The data tracker module 108 may communicate with the database node 114c in a similar manner as described above to monitor the data 114c as it moves from the database node 114b to the database node 114c. The data tracker module 108 may transmit information related to the monitoring of the data 202 to the data analyzer module 110 for further processing and analysis. In some embodiments, the data tracker module 108 may store the copy of the data retrieved from the database node 114c and information related to the monitoring of the data 202 (outcome data) in the cockpit schema database 112.

The data analyzer module 110 may further analyze the data and information obtained from the data tracker module 108 to turn the information into intelligent information. For example, various data and information related to their changes and movements across the database nodes may be compiled, for example, in the cockpit schema database 112. According to various embodiments of the disclosure, the data analyzer module 110 may analyze the compiled data (or a portion of the compiled data) collectively to generate trend data. For example, the data analyzer module 110 may determine that data of a specific data type (e.g., a customer's purchase transaction counter) is usually increased when such a data is moved from the database node 114a to the database node 114b based on a specific work flow (e.g., a work flow related to performing a new customer payment transaction). The data analyzer module 110 may also store such generated trend data in the cockpit schema database 112, and subsequently use the trend data in one or more ways.

In this example, when it is determined that the copy of the data 202 at the database node 114b is different from the copy of the data 202 at the database node 114a, the data analyzer module may determine whether the change is an expected change based on trend data developed previously. If the data 202 is of a customer purchase transaction counter type, the data analyzer module 110 may determine that the change is an expected change if the change is an increase in number, and conversely may determine that the change is an unexpected change if the change is a decrease in number or the increase in number is too large.

In another example, based on historical data, the data analyzer module 110 may determine an amount of data of a specific type is usually moved from one database system to another database system. The data analyzer module 110 may then determine whether the current amount of data of the specific type moving between the database systems corresponds to the trend data, and any deviation of the amount may cause the data analyzer module 110 to raise a flag and provide an alert, for example.

In some embodiments, the data analyzer 110 may correlate a change of the data (e.g., the data 202) to another data in any one of the database nodes 114a-114d (e.g., the software codes of a work flow that causes the change of the data). As a result, when it is determined that the changed data is unexpected (e.g., either based on analyzing the trend data as discussed above, or from a new data indicating a problem with the data 202), the data analyzer 110 may associate the bug with the software codes related to the particular work flow. The data analyzer 110 may determine that, based on the modification and movement data monitored by the data tracker 108 and stored in the cockpit schema database 112, the software code has been recently modified (e.g., within a predetermined amount of time such as a day, a week, etc.). Thus, the data analyzer 110 may associate the data related to the modification of the software code to the new data indicating the bug or data issue upstream in the particular work flow.

Furthermore, based on the generated trend data, the data analyzer module 110 may predict a future event. For example, by analyzing the trend data (e.g., using machine learning techniques, pattern matching techniques, etc.), the data analyzer module 110 may determine that many data quality issues arise when software codes related to two different work flows (e.g., a first work flow and a second work flow) are updated/modified within a short span of time (e.g., within a predetermined amount of time). Thus, when it is determined that the software codes related to the first and second work flows have been modified in quick succession (e.g., within the predetermined amount of time), the data analyzer module 110 may predict that an increase number of software bug tickets will be generated in the near future. Based on the trend analysis, data quality issues may be addressed and fixed before the issues impacted customers or other work flows within the enterprise system.

With this information, the data analyzer module 110 may provide a warning, for example, a warning message on a web interface via the web server 106, that an increased number of data quality issues may arise to the users. In some embodiments, the data analyzer module 110 may provide preventive measures to prevent the increase of the number of data quality issues. For example, upon detecting that the software codes related to the first work flow have been modified, the data analyzer module 110 may prevent the software codes related to the second work flow from being modified (e.g., denying storing a new version of the software code related to the second work flow in any one of the database nodes 114a-114d). In another example, the data analyzer module 110 may only give out a warning to the user when the user tries to save a new version of the software codes related to the second work flow in any one of the database nodes 114a-114d.

According to various embodiments of the disclosure, the data analyzer 110 may analyze the compiled data in the cockpit schema database 112 by generating multiple queries, and run the multiple queries against the cockpit schema database 112. In some of these embodiments, the data analyzer 110 may run the queries even before receiving any user requests for presenting a report based on the compiled data. The data analyzer module 110 may generate queries based on different domains within the enterprise (e.g., querying data related to each domain, etc.), different work flows (e.g., querying data related to each work flow, querying data related to work flows that are associated with each other, etc.), and the like, and store the result sets from running the queries in the cockpit schema database 112. For example, the data analyzer module 110 may query the outcome data related to a particular domain, or the outcome data related to a particular work flow. The resulting outcome data set may be used by the data analyzer to generate performance metrics (e.g., performance metrics 204) for the corresponding domain and/or work flow. The data analyzer module 110 may then generate reports based on the performance metrics and other data stored in the cockpit schema database 112 upon requests from users.

Referring back to FIG. 1, the enterprise cockpit server 102 may provide an interactive interface, for example, a web interface by using the web server 106. The interactive interface may enable a user to view different reports or performance metrics related to a particular domain or a work flow within the enterprise system, for example, via a user computer 132 (e.g., a personal computer, a tablet, a phone, etc.). For example, by making a request to view software bug statistics, (e.g., by selecting an element on the interactive interface), the data analyzer module 110 may map the request to one or more pre-generated queries, and retrieve the result sets corresponding to the one or more pre-generated queries (e.g., queries related to numbers of software bugs or data quality issues issued for a domain each month in the last 12 months, etc.) from the cockpit schema database 112. The data analyzer module 110 may then generate a report based on the retrieved result sets and present to the user via the interactive interface. As discussed above, the user request may also come in different forms. Instead of an interaction with the presented data, the user request may be provided in a text box and may include natural language. In such embodiments, the system may also include a natural language processor to derive semantics based on the received request in natural language and then map the derived semantics to one or more of the different pre-generated queries.

In addition to the retrieved data from the cockpit schema database 112, the generated report may also include additional interactive elements that enable the user to provide another request for an additional report. For example, on the presented report of the software bugs or data quality issues for the domain, the user may select a particular software bug or a data quality issue and view details of the software bug or the data quality issue. As discussed above, the data analyzer module 110 may determine a correlation between a software bug (or a data quality issue) and a modification of a software code. As such, the data analyzer module 110 may enable the user to trace the cause of the bug to a particular software code release. In some embodiments, the data analyzer module 110 may also present the identity of the software developer who modified and saved that particular software code release in one of the database nodes 114a-114d in the interactive database, based on information retrieved from the cockpit schema database 112. In some of these embodiments, the web server 106 may present the additional detail information in an overlap on top of the interactive interface, or in a pop-up window on top of the interactive interface.

In addition to showing data issue metrics of the domains to the user, the enterprise cockpit server 102 may also present the trend analysis of the compiled data, warnings based on the trend analysis, and preventive measures, as discussed above. Additional reports may also include performance metrics related to each of the different database nodes 114a-114d, stages of software development for each project and/or work flow, database node(s) and/or domain(s) impacted by each data, and the like.

Furthermore, instead of or in addition to providing the interactive interface, the enterprise cockpit server 102 may be configured by the user to provide periodic reports in an e-mail format to one or more e-mail servers (e.g., e-mail server 134), and/or to an external server 136 (e.g., a server associated with a business partner or a customer) for further processing.

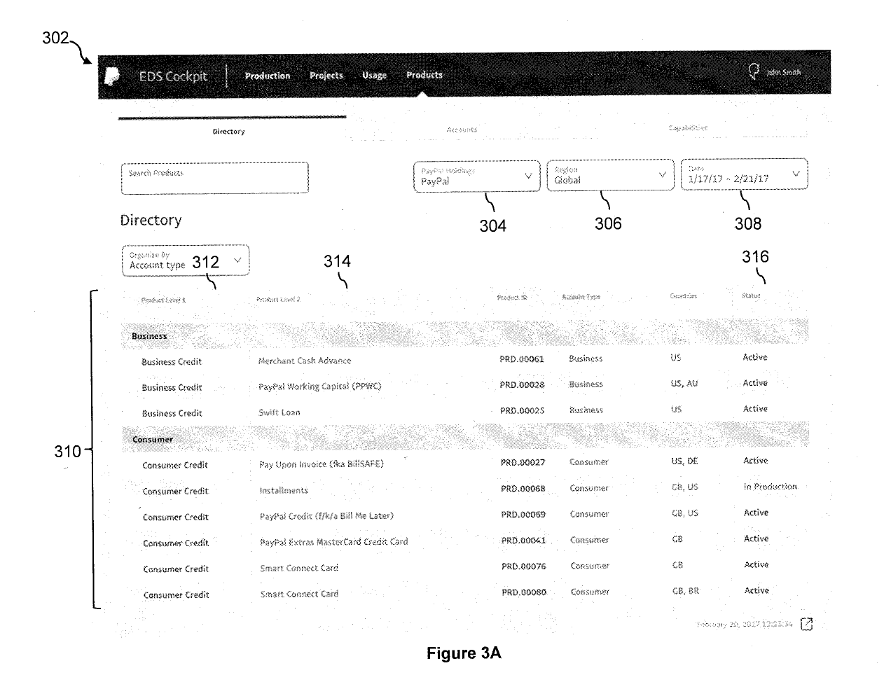

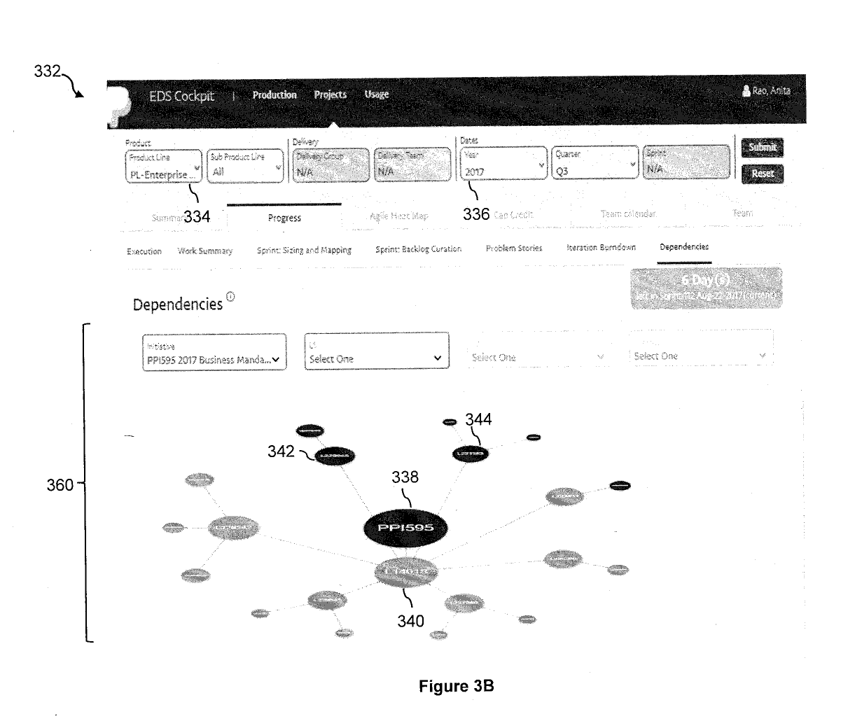

FIG. 3A illustrates an example interactive interface 302 generated by the enterprise cockpit server 102 for reporting a production status of various software projects across multiple domains within an enterprise system. The interactive interface 302 includes selection elements 304, 306, and 308 that enable a user to provide various criteria for retrieving performance data of software projects managed across the multiple domains within the enterprise system. For example, the selection elements 304, 306, and 308 may enable the user to select a domain (in selection element 304), to select a geographical region (in selection element 306), and a date range (in selection element 308). The enterprise cockpit server 102 may then map the selected criteria to one or more pre-generated queries, may retrieve the result sets from the cockpit schema database 112 based on the pre-generated queries, and may generate a report 310 based on the retrieved result set for presentation. In this example, the report 310 presented in the interactive interface 302 shows various software projects that satisfy the selected criteria and their corresponding status. For example, the report includes the software project “Merchant Cash Advance,” “PayPal Working Capital (PPWC),” “Swift Loan,” “Pay Upon Invoice,” “Installments,” and others, as indicated by the software project names column 314. As shown, the projects may be presented based on different categories or domains. In this example, the software projects may either belong to a “Business Credit” domain or a “Consumer Credit” domain, as indicated by the column 312. The report 310 may also include a status column 316 indicating a status of each corresponding project. For example, the report 310 indicates that the project “Merchant Cash Advance” has an “active” status, while the project “Installments” has an “in production” status. These statuses may be generated by the enterprise cockpit server 102 based on the performance metrics associated with data related to these projects across the multiple database nodes according to various embodiments disclosed herein. For example, if the scheduled data flow requires that the data associated with a software project (e.g., the software code) to be moved from the database node 114a to the database node 114b, and then to the database node 114c, but the performance metric indicates that the data has not arrived at the database node 114c, the enterprise cockpit server 102 may determine that the software project is still in production. On the other hand, if the performance metrics indicate that the data (e.g., the software code) has completed the movement to the database node 114c on schedule, the enterprise cockpit server 102 may determine that the software project is active.

In addition to providing information, according to various embodiments of the disclosure, the generated report 310 may be interactive and enables the user to select one or more additional elements within the report 310. For example, the names of the project listed in the report 310 may be active links which the user may select. Upon receiving a selection of a project name (e.g., the project “Merchant Cash Advance”), the enterprise cockpit server 102 may map such an interaction to other one or more pre-generated queries, may retrieve result sets of these other one or more pre-generated queries, and may present an additional report or a separate report from the report 310. For example, the enterprise cockpit server 102 may consider selecting the project name “Merchant Cash Advance” as an indication to provide additional detail information about the specific project. Thus, the enterprise cockpit server 102 may map the interaction to the other one or more queries to retrieve detailed data associated with the software project “Merchant Cash Advance,” and provide a report based on the retrieved data. The additional information may include finance information, personnel information, and detailed work progress information associated with the project. The new report may be presented as an overlap on top of the interactive interface 302, or as a pop-up window.

FIG. 3B illustrates another interactive interface 332 generated by the enterprise cockpit server 102 for presenting dependency relationships among multiple projects across different domains within an enterprise system. The interactive interface 332 includes selection elements, such as selection elements 334 and 336 that enable a user to provide various criteria for retrieving dependency data of software projects managed across the multiple domains within the enterprise system. For example, the selection elements 334 and 336 may enable the user to select a domain (in selection element 334) and a date range (in selection element 336). The enterprise cockpit server 102 may then map the selected criteria to one or more pre-generated queries, may retrieve the result sets from the cockpit schema database 112 based on the pre-generated queries, and may generate a report 360 based on the retrieved result set for presentation. In this example, the report 360 presented in the interactive interface 302 shows various projects that satisfy the selected criteria, such as projects 338-344, as a graph with nodes and edges. In particular, the report 360 presents each project as a node and each relationship between two projects as an edge between the corresponding nodes. For example, the project 338 is shown to be connected with projects 340, 342, and 344, indicating that a dependency relationship exists between the project 338 and each of the other projects 340-344.

In some embodiments, in addition to presenting a relationship between two projects, the strength of the relationship may also be presented in the report 360. In this example, the strength of a relationship may be indicated by a number of edges between two different nodes. As shown, there are three edges between the project 338 and the project 340, while there is only one edge between the project 338 and the project 342, indicating that the dependency relationship between the project 338 and the project 340 is stronger than (e.g., three times as strong as) the dependency relationship between the project 448 and the project 342.

According to various embodiments of the disclosure, the enterprise cockpit server 102 may determine a dependency relationship between two projects exists when at least one data that the enterprise cockpit server 102 monitors is used by the work flows associated with the two projects. In addition, the more data that are shared by the work flows associated with the two projects, the stronger the dependency relationship between the two projects.

In addition to providing information, according to various embodiments of the disclosure, the generated report 360 may be interactive and enables the user to select one or more additional elements within the report 360. For example, each node (and/or edge) presented in the report 360 may be an active link which the user may select. Upon receiving a selection of a node (or an edge) (e.g., the node corresponds to the project 338), the enterprise cockpit server 102 may map such an interaction to other one or more pre-generated queries, may retrieve result sets of these other one or more pre-generated queries, and may present an additional report or a separate report from the report 360. For example, the enterprise cockpit server 102 may consider selecting the project 338 as an indication to provide additional detail information about the specific project. Thus, the enterprise cockpit server 102 may map the interaction to the other one or more queries to retrieve detailed data associated with the project 338, and provide a report based on the retrieved data. The additional information may include finance information, personnel information, and detailed work progress information associated with the project 338. Similarly, the enterprise cockpit server 102 may consider selecting an edge (e.g., the edge between the project 338 and the project 342) as an indication to provide additional detail information about the dependency relationship. Thus, the enterprise cockpit server 102 may map the interaction to the other one or more queries to retrieve detailed data associated with the relationship, and provide a report based on the retrieved data. The additional information may include information of all of the shared data, changes and movements of the shared data, and other information. The new report may be presented as an overlap on top of the interactive interface 332, or as a pop-up window.

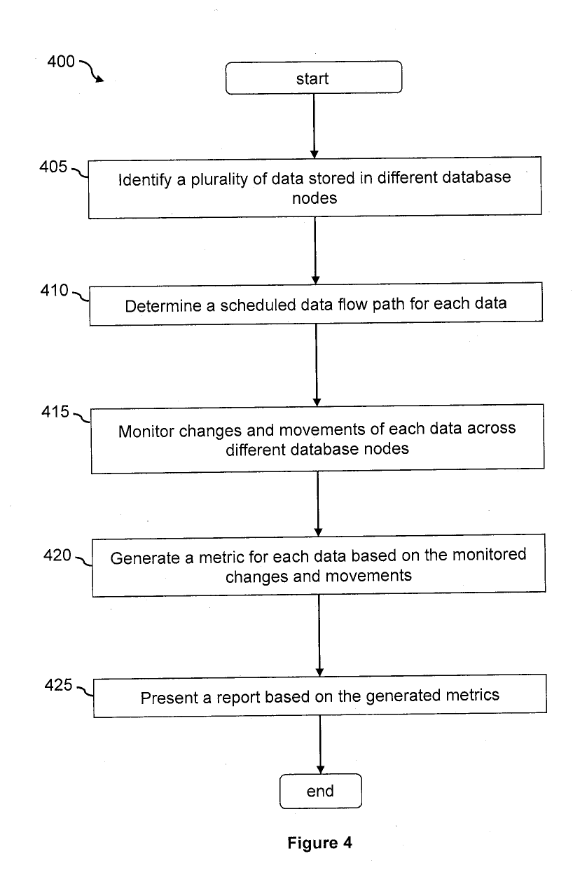

FIG. 4 illustrates a process 400 for providing a visualization of enterprise data based on monitoring changes and movements of data with an enterprise according to various embodiments of the disclosure. In some embodiments, the process 400 may be performed by one or more modules of the enterprise cockpit server 102. The process 400 begins by identifying (at step 405) data stored in different database nodes. For example, as discussed above, the data tracker module 108 may identify new data that is stored in any one of the database nodes 114a-114d by periodically sending a request to the database nodes 114a-114d. Alternatively, each of the database nodes 114a-114d may be configured to automatically push newly stored data to the data tracker module 108 when new stored data is saved in the corresponding database node.

Next, the process 400 determines (at step 410) a scheduled data flow path for each identified data. In some embodiments, as the data is created and/or saved for a particular work flow, the generator of the data may insert information identifying the work flow and information related to a planned data flow of the data according to the work flow. As such, the data tracker module 108 may extract the metadata to determine which work flow(s) use the data and the scheduled data flow path for each data. The scheduled data flow path may indicate a planned movement of the data across two or more database nodes at specific times.

The process 400 then monitors (at step 415) changes of each data and movements of each data across the different database nodes. For example, the data tracker module 108 may communicate with a database node when a data is scheduled to arrive at the database node to determine whether the data has arrived on schedule and whether the data has been modified from a previous copy (e.g., a copy of the data from the previous database node) or whether the data has been updated within the database node. The data tracker module 108 along with the data analyzer module 110 may generate outcome data indicating whether the data moves according to plan and/or whether the data changes at the database node or along the route. The process 400 may then generate (at step 420) a performance metric for each data based on the monitored changes and movements. In some embodiments, the data analyzer module 110 may generate multiple queries and may run the queries against the compiled data and associated performance metrics. Upon receiving a user request, the process 400 presents (at step 425) a performance report via an interface.

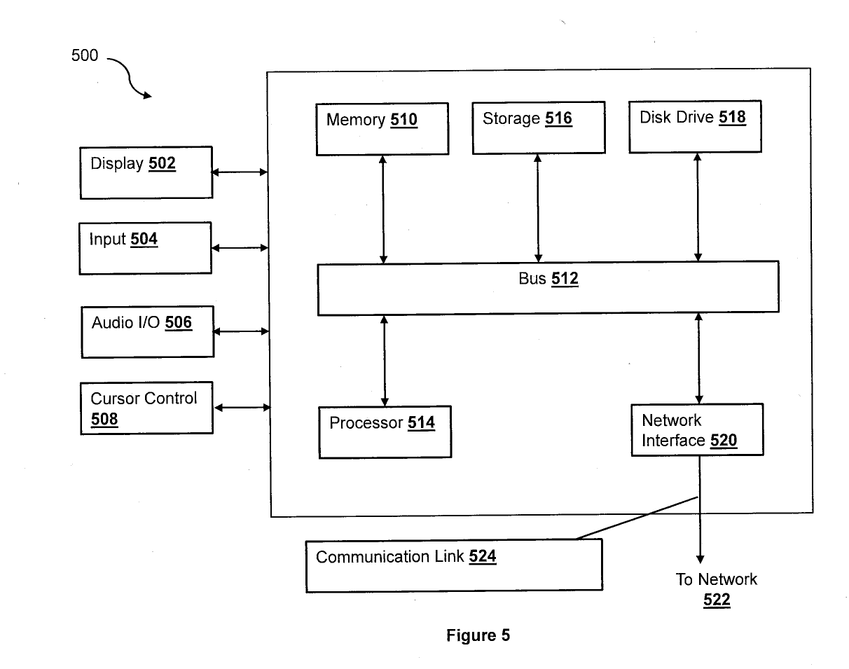

FIG. 5 is a block diagram of a computer system 500 suitable for implementing one or more embodiments of the present disclosure, including the application servers (e.g., the application servers 110 and 120) of the database system 104, and the requesting device 102. In various implementations, the requesting device 102 may include a mobile cellular phone, personal computer (PC), laptop, tablet, wearable computing device, etc. adapted for wireless communication, and each of the application servers 110 and 120 may include a network computing device, such as a server. Thus, it should be appreciated that the devices 110, 120, and 102 may be implemented as computer system 500 in a manner as follows.

Computer system 500 includes a bus 512 or other communication mechanism for communicating information data, signals, and information between various components of computer system 500. Components include an input/output (I/O) component 504 that processes a user (i.e., sender, recipient, service provider) action, such as selecting keys from a keypad/keyboard, selecting one or more buttons or links, etc., and sends a corresponding signal to bus 512. I/O component 504 may also include an output component, such as a display 502 and a cursor control 508 (such as a keyboard, keypad, mouse, etc.). The display 502 may be configured to present a login page for logging into a user account or a checkout page for purchasing an item from a merchant associated with the merchant server 122. An optional audio input/output component 506 may also be included to allow a user to use voice for inputting information by converting audio signals. Audio I/O component 506 may allow the user to hear audio. A transceiver or network interface 520 transmits and receives signals between computer system 500 and other devices, such as another user device, a merchant server, or a service provider server via network 522. In one embodiment, the transmission is wireless, although other transmission mediums and methods may also be suitable. A processor 514, which can be a micro-controller, digital signal processor (DSP), or other processing component, processes these various signals, such as for display on computer system 500 or transmission to other devices via a communication link 524. Processor 514 may also control transmission of information, such as cookies or IP addresses, to other devices.

Components of computer system 500 also include a system memory component 510 (e.g., RAM), a static storage component 516 (e.g., ROM), and/or a disk drive 518 (e.g., a solid state drive, a hard drive). Computer system 500 performs specific operations by processor 514 and other components by executing one or more sequences of instructions contained in system memory component 510. For example, processor 514 can receive purchase requests from a merchant, process the purchase requests, assess a user's purchase profile, increase a user's conversion rate, identify digital wallets of a user, determine which digital wallets are most applicable to a user and should be recommended, and provide merchants with the recommended digital wallets. Logic may be encoded in a computer readable medium, which may refer to any medium that participates in providing instructions to processor 514 for execution. Such a medium may take many forms, including but not limited to, non-volatile media, volatile media, and transmission media. In various implementations, non-volatile media includes optical or magnetic disks, volatile media includes dynamic memory, such as system memory component 510, and transmission media includes coaxial cables, copper wire, and fiber optics, including wires that comprise bus 512. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 524 to the network (e.g., such as a LAN, WLAN, PTSN, and/or various other wired or wireless networks, including telecommunications, mobile, and cellular phone networks) may perform instruction sequences to practice the present disclosure in coordination with one another.

In view of the present disclosure, it will be appreciated that various methods and systems have been described according to one or more embodiments for facilitating a digital wallet transaction.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A method comprising:
identifying, by one or more hardware processors, a plurality of data stored in different database nodes within an enterprise computing environment of an enterprise system, wherein the plurality of data is associated with different work flows implemented by the enterprise system;
extracting, by the one or more hardware processors for each data in the plurality of data, metadata from the data to determine a scheduled data flow path of the data, wherein the scheduled data flow path indicates a series of database nodes that the data is expected to traverse;
monitoring, by the one or more hardware processors for each data in the plurality of data, movements and changes of the data across the different database nodes;
in response to monitoring the movements and changes of the data, generating, by the one or more hardware processors, performance metric for the data indicating an amount of deviation between the monitored movements and changes of the data and the scheduled data flow path associated with the data; and
in response to a user request, presenting, by the one or more hardware processors via an interactive user interface, a performance report for a first work flow based on the performance metrics generated for data associated with the first work flow.

2. The method of claim 1, wherein generating the performance metric for the data comprises generating, by the one or more hardware processors for the data, outcome data indicating one or more performance issues related to the data at each database node based on the scheduled data flow path associated with the data.

3. The method of claim 1, further comprising prior to receiving the user request, running, by the one or more hardware processors, a set of queries against the performance metrics to generate performance data for the different work flows.

4. The method of claim 3, further comprising in response to the user request, generating, by the one or more hardware processors, the performance report based on a result of at least one query from the set of queries.

5. The method of claim 3, wherein the performance report comprises results based on running a first query in the set of queries against the performance metrics, wherein the method further comprises in response to a second user request received via the interactive user interface, presenting, by the one or more hardware processors for the first work flow, a second performance report comprising results based on running a second query in the set of queries against the performance metrics.

6. The method of claim 1, further comprising computing, by the one or more hardware processors for each of the different work flows, trend data indicating a performance trend of the work flow based on the generated performance metrics associated with the work flow, wherein the performance report comprises a presentation of the trend data.

7. The method of claim 6, further comprising predicting, by the one or more hardware processors for the each of the different work flows, future performance data based on the computed trend data, wherein the performance report further comprises a presentation of the predicted future performance.

8. The method of claim 1, wherein the performance report comprises one or more performance issues related to the movements of first data associated with a first work flow, wherein the method further comprises tracing, by the one or more hardware processors via the interactive user interface, a cause of the one or more performance issues in response to a second user request.

9. The method of claim 8, wherein the cause of the one or more performance issues is related to a software bug in the first work flow.

10. The method of claim 8, further comprising identifying, by the one or more hardware processors via the interactive tool, a second work flow affected by the one or more performance issues associated with the first work flow in response to a third user request.

11. The method of claim 1, wherein the user request is in a natural language format, where the method further comprises parsing the user request to derive a query, wherein the performance report is presented based on the derived query.

12. The method of claim 1, further comprising generating, by the one or more hardware processors, for each data in the plurality of data, information related to a scheduled data flow path based on a data type and a work flow associated with the data.

13. A system comprising:
a non-transitory memory; and
one or more hardware processors coupled to the non-transitory memory and configured to read instructions from the non-transitory memory to cause the system to perform operations comprising:
identifying a plurality of data stored in different database nodes within an enterprise computing environment of an enterprise system, wherein the plurality of data is associated with different work flows implemented by the enterprise system;
extracting, by the one or more hardware processors for each data in the plurality of data, metadata from the data to determine a scheduled data flow path of the data across the different database nodes within the enterprise computing environment;
monitoring, by the one or more hardware processors for each data in the plurality of data, movements of the data across the different database nodes and work flows from the different work flows that cause the movements of the data;
in response to monitoring the movements of the data, generating dependency data indicating dependency relationships among the different work flows based on the monitored movements of the data and the scheduled data flow path associated with the data; and
in response to a user request, presenting, by the one or more hardware processors via an interactive user interface, a dependency report based on the generated dependency data.

14. The system of claim 13, wherein generating the dependency data comprises determining the two or more work flows that share same data within the enterprise system.

15. The system of claim 14, wherein each of the two or more work flows causes the same data to move across the database nodes according to different portions of the associated scheduled data flow path.

16. The system of claim 13, wherein the dependency report comprises a graph having nodes representing the different work flows and edges representing dependency relationships between the work flows.

17. The system of claim 13, wherein the operations further comprise prior to receiving the user request, running a set of queries against the dependency data.

18. The system of claim 17, wherein the dependency report is generated based on a result of at least one query from the set of queries.

19. A non-transitory computer readable medium comprising machine-readable instructions which when executed by one or more processors of a machine are adapted to cause the machine to perform operations comprising:
identifying a plurality of data stored in different database nodes within an enterprise computing environment of an enterprise system, wherein the plurality of data is associated with different work flows implemented by the enterprise system;
extracting, for each data in the plurality of data, metadata from the data to determine a scheduled data flow path of the data, wherein the scheduled data flow path indicates a series of database nodes that the data is expected to traverse, a time that the data is expected to arrive at each database node in the series, and an expected change of the data in each database nodes in the series;
monitoring, for each data in the plurality of data, movements and changes of the data across the different database nodes;
in response to monitoring the movements and changes of the data, generating a performance metric for the data indicating an amount of deviation between the monitored movements and changes of the data and the scheduled data flow path associated with the data; and
in response to a user request, presenting, via an interactive user interface, a performance report for a first work flow based on the performance metrics generated for data associated with the first work flow.

20. The non-transitory computer readable medium of claim 19, wherein the operations further comprise computing, for each of the different work flows, trend data indicating a performance trend of the work flow based on the generated performance metrics associated with the work flow, wherein the performance report comprises a presentation of the trend data.
